(19) United States
(12) Patent Application Publication
(10) Pub. No.: US 2015/0050386 A1
(43) Pub. Date: Feb. 19, 2015

(54) QUARK BASE MIX HAVING ENHANCED TASTE PROPERTIES III

(71) Applicant: DMK Deutsches Milchkontor GmbH, Zeven (DE)

(72) Inventors: Marina Schomacker, Sittensen (DE); Michael Hahn, Heerlingen (DE); Sven-Rainer Döring, Zeven (DE)

(21) Appl. No.: 14/459,786

(22) Filed: Aug. 14, 2014

(30) Foreign Application Priority Data
Aug. 18, 2013 (EP) 13 180 796.8

(51) Int. Cl. A23C 9/12; A23C 9/142

(52) U.S. Cl. CPC A23C 9/1203; A23C 9/1422; A23C 9/1427; A23Y 2240/75; A23Y 2260/00; A23Y 2240/41; A23Y 2240/21
USPC 426/43; 426/580

(57) ABSTRACT

A quark base mix is proposed having enhanced taste properties which is obtainable in that
(a) raw milk is subjected to a temperature treatment and the cream is separated off,
(b) the resultant skimmed milk is subjected to an ultrafiltration and in this case a first retentate R1 which contains a milk protein concentrate is produced, and a first permeate P1 is produced,
(c) the first permeate P1 is subjected to a nanofiltration and/or reverse osmosis and in this case a second retentate R2 which contains alkali metal salts is produced, and a second permeate P2 is produced,
(d) optionally the second retentate R2 is subjected to an alkaline demineralization and in this case a third retentate R3 which contains phosphate salts is produced and a third permeate P3 is produced,
(e) the third permeate P3 is combined with the retentate R1 in such a manner that a non-acidified quark base mix is formed, and
(f) the resultant mixture is subjected to a temperature treatment until denaturation occurs, and finally
(g) the denatured product is admixed with starter cultures and rennet and optionally
(h) the quark base mix thus obtained after completion of fermentation is adjusted to a defined dry matter content and protein content,
   and in step (g), as starter culture
(i) a first mixture of five microorganisms comprising (i-1) Streptococcus thermophilus, (i-2) Leuconostoc species, (i-3) Lactococcus lactis subsp. lactis biovar diacetylactis, (i-4) Lactococcus lactis subsp. lactis and (i-5) Lactococcus lactis subsp. cremoris, and
(ii) a second mixture of three microorganisms comprising (ii-1) Streptococcus thermophilus, (ii-2) Lactococcus lactis subsp. lactis and (ii-3) Lactococcus lactis subsp. cremoris
   is used.

### FIELD OF THE INVENTION

The invention is in the field of milk products and relates to an enhanced taste quark and also to a method for production thereof.

### PRIOR ART

To produce quark, generally skimmed milk is subjected to a temperature treatment and the proteins therein are denatured.

The subsequent addition of lactic acid bacteria and rennet performs what is termed coagulation (phase reversal) of milk. The casein coagulates and forms what is termed coagulum in the art. After ripening (8 to 20 h) the coagulum is agitated. The whey separation is initiated thereby, and the two phases are then separated in the separator. The liquid acid whey is processed in other ways and the quark base mix is adjusted to the desired fat and protein content by adding cream.

The technical production methods are dominated by corresponding separation methods. By varying the separation conditions and technical modifications of the separators, currently a multiplicity of method configurations are possible. The skimmed milk input, at a protein content of the skimmed milk of 3.3 to 3.5% by weight, is in the range of 4.10 to 4.15 kg of skimmed milk per kilogram of skimmed-milk quark or fresh cheese to be produced (4.10 to 4.15 kg of skimmed milk/kg of skimmed-milk quark), if the latter have 18% dry matter. Therefore, 3.10 to 3.15 kg of acid whey are produced per kilogram of skimmed-milk quark (3.10 to 3.15 kg of acid whey/kg of skimmed-milk quark). The protein content in this case reaches orders of magnitude of 12.6 to 12.8% by weight.

In addition to the production methods known by separation, methods are also known in which the fermented process milk is concentrated by means of ultrafiltration. Thus, US 2003/0129275 A1 (Lact Innovation) discloses, e.g., that in the production of cheese and quark, microfiltration and ultrafiltration steps can also be used. The employment of microfiltration on skimmed milk for producing cheese and whey protein products is described, for example, in US 2003/0077357 A1 (Cornell Research Foundation).

EP1752046 A1 (Tuchenhagen) discloses a method for producing fermented milk products in which process milk is fermented, the fermentation product is subjected to a microfiltration and only the acidified retentate is further processed.

These methods of the prior art, however, have two considerable disadvantages:
(i) If skimmed milk is preconcentrated by means of ultrafiltration to a quark base mix and is then acidified, the product has a very bitter taste and is of unacceptable sensory quality. This sensory fault is induced in particular by the presence of phosphates. Alkali metal ions, in particular sodium, have a tendency to give rise to a metallic taste. The methods of the prior art for concentrating non-acidified skimmed milk to form quark have hitherto not been able to separate off phosphates and alkali metal ions quantitatively, and so amounts still remain in the product such that taste impairment cannot be prevented.
(ii) In addition, the acid whey is a coupled product which, as such, is undesirable. Separating off the whey from the curd is technically complex and delivers a product for which there is only a small market.

The object of the present invention was therefore to provide a quark mix having enhanced taste properties which, without addition of additives, is directly ready to package and ready to eat. At the same time, the corresponding production method should dispense with the production of acid whey as waste product.

### DESCRIPTION OF THE INVENTION

A first subject matter of the invention relates to a quark base mix having enhanced taste properties which is obtainable in that
(a) raw milk is subjected to a temperature treatment and the cream is separated off,
(b) the resultant skimmed milk is subjected to an ultrafiltration and in this case a first retentate R1 which contains a milk protein concentrate is produced, and a first permeate P1 is produced,
(c) the first permeate P1 is subjected to a nanofiltration and/or reverse osmosis and in this case a second retentate R2 which contains alkali metal salts is produced, and a second permeate P2 is produced,
(d) optionally the second retentate R2 is subjected to an alkaline demineralization and in this case a third retentate R3 which contains phosphate salts is produced, and a third permeate P3 is produced,
(e) the third permeate P3 is combined with the retentate R1 in such a manner that a non-acidified quark base mix is formed, and
(f) the resultant mixture is subjected to a temperature treatment until denaturation occurs,
(g) the denatured product is admixed with starter cultures and rennet and optionally
(h) the quark base mix thus obtained after completion of fermentation is adjusted to a defined dry matter content and protein content,
   and in step (g), as starter culture
(i) a first mixture of five microorganisms comprising (i-1) Streptococcus thermophilus, (i-2) Leuconostoc species, (i-3) Lactococcus lactis subsp. lactis biovar diacetylactis, (i-4) Lactococcus lactis subsp. lactis and (i-5) Lactococcus lactis subsp. cremoris, and
(ii) a second mixture of three microorganisms comprising (ii-1) Streptococcus thermophilus, Lactococcus lactis subsp. lactis and (ii-3) Lactococcus lactis subsp. cremoris
   is used.

A second subject matter of the invention is directed towards a method for producing a quark base mix having enhanced taste properties, in which
(a) raw milk is subjected to a temperature treatment and the cream is separated off,
(b) the resultant skimmed milk is subjected to an ultrafiltration and in this case a first retentate R1 which contains a milk protein concentrate is produced, and a first permeate P1 is produced,
(c) the first permeate P1 is subjected to a nanofiltration and/or reverse osmosis and in this case a second retentate R2 which contains alkali metal salts is produced, and a second permeate P2 is produced,
(d) optionally the second retentate R2 is subjected to an alkaline demineralization and in this case a third retentate R3 which contains phosphate salts is produced, and a third permeate P3 is produced,
(e) the third permeate P3 is combined with the retentate R1 in such a manner that a non-acidified quark base mix is formed, and
(f) the resultant mixture is subjected to a temperature treatment until denaturation occurs, and finally
(g) the denatured product is admixed with starter cultures and rennet and optionally
(h) the quark base mix thus obtained after completion of fermentation is adjusted to a defined dry matter content and protein content, and in step (g), as starter culture
(i) a first mixture of five microorganisms comprising (i-1) Streptococcus thermophilus, (i-2) Leuconostoc species, (i-3) Lactococcus lactis subsp. lactis biovar diacetylactis, (i-4) Lactococcus lactis subsp. lactis and (i-5) Lactococcus lactis subsp. cremoris, and
(ii) a second mixture of three microorganisms comprising (ii-1) Streptococcus thermophilus, (ii-2) Lactococcus lactis subsp. lactis and (ii-3) Lactococcus lactis subsp. cremoris
   is used.

Surprisingly, it has been found that using the method according to the invention, a quark which is significantly enhanced in taste is obtained and at the same time the undesirable production of acid whey which must also still be separated off in a complex manner is avoided.

In particular, the use of the selected starter cultures leads to a quark which has a creamy taste and does not leave behind a slimy overall impression. As a result of the method described here, in addition, the acid whey production can be reduced in that, when the protein fraction and the demineralized milk permeate are combined, only as much permeate is added as is required in order to achieve the required values in the end product (e.g. dietary quark having at least 18% by weight dry matter and at least 12% by absolute weight protein).

The remaining amount of milk permeate can be further used economically; for example for producing lactose or as expedient filler in other products.

### BRIEF DESCRIPTION OF THE DRAWING

The FIGURE schematically illustrates a conventional method for quark production (left) versus the method according to the invention (right).

### DESCRIPTION OF THE PREFERRED EMBODIMENTS

### Production of Skimmed Milk

To produce skimmed milk, solid non-milk components are initially separated off, and also the fat fraction of about 4% by weight is skimmed from the raw milk. This usually takes place in a special unit, preferably a separator. Such units are sufficiently known from the prior art. Separators from GEA Westfalia Separator GmbH are very widespread in the milk industry, with which the two steps can be carried out individually or together.¹ Corresponding components are also described, for example, in DE 10036085 C1 (Westfalia) and are very well known to those skilled in the art, and as a result for carrying out these method steps, no explanations are required, since they are considered part of general specialist knowledge. ¹ (http://www.westfalia-separator.com/de/anwendungen/molkereitechnik/milch-molke.html).

The raw milk is preferably heat-treated in heat exchangers, wherein especially plate heat exchangers have proved to be particularly suitable. There is a temperature gradient on the heat exchangers which, however, is selected in such a manner that the raw milk is heated for a residence time of at least 20 seconds and at most 60 seconds, preferably about 30 seconds, to a temperature of about 70 to 80° C. and in particular about 72 to 74° C.

### Ultrafiltration, Microfiltration and Reverse Osmosis

In the second method step, the skimmed milk is separated off using ultrafiltration and/or microfiltration into a milk protein concentrate which occurs as retentate, and a milk permeate.

The expression ultrafiltration is taken to mean filtration through membranes of a pore size <0.1 μm, whereas filtration in the case of pore sizes >0.1 μm is usually termed microfiltration. In both cases these are purely physical, i.e. mechanical, membrane separation methods which operate according to the principle of mechanical size exclusion: all particles in the fluids which are larger than the membrane pores are retained by the membrane. The driving force in both separation methods is the differential pressure between feed and outflow of the filter surface, which is between 0.1 and 10 bar. The material of the filter surface can consist of stainless steel, plastic, ceramic or textile woven fabric, depending on the field of use. There are various types of the filter elements: candle filters, flat membranes, spiral-wound membranes, pocket filters and hollow fibre modules, which are all suitable in principle in the context of the present invention.

Ultrafiltration preferably proceeds at temperatures in the range of about 10 to about 55° C., preferably 10 to 20° C., wherein the membranes preferably have a pore diameter with a retention in the range of about 1000 to about 50 000, and preferably about 5000 to about 25 000 daltons. Preferably, the filter elements are what are termed spiral-wound membranes or plate-frame modules made of polysulphone or polyethylene membranes.

The use of microfiltration has the advantage that some of the whey proteins are also separated off and thus a bitter taste note in the end product is avoided.

An alternative to ultrafiltration is reverse osmosis. In this case, the skimmed milk is de-watered using a semipermeable membrane and as a result the concentration of the valuable milk proteins is increased. The principle is to expose the system to a pressure which is higher than the pressure which is formed owing to the osmotic demand for concentration equalization. As a result, the molecules of the solvent can migrate against their “natural” osmotic propagation direction. The method forces them into the compartment in which dissolved substances are present in less concentrated form. Milk has an osmotic pressure of less than 2 bar, and the pressure employed for the reverse osmosis of milk is 3 to 30 bar, depending on the membrane and plant configuration used. The osmotic membrane which lets only the carrier liquid (solvent) through and retains the dissolved substances (solute) must be able to withstand these high pressures. When the pressure difference more than compensates for the osmotic gradient, the solvent molecules pass through the membrane, as with a filter, whereas the milk proteins are retained. In contrast to a classical membrane filter, osmosis membranes do not have continuous pores. Reverse osmosis is preferably reverse osmosis carried out at a temperature in the range of 10 to 55° C., preferably 10 to 20° C., with semi-permeable membranes which have a selectivity of 0 to 1000 daltons.

### Nanofiltration

The ultrafiltration is followed as a third method step by separating off alkali metal salts, especially sodium and potassium salts, which is achieved via nanofiltration.

Nanofiltration is classified between ultrafiltration and reverse osmosis, and is carried out in principle in a similar manner to ultrafiltration. However, the membranes are even more finely pored, and the selectivity is between 100 and 1000 daltons (corresponding to a median pore diameter of 0.01 to 0.001 μm), wherein the differential pressure is generally about 3 to 40 bar. Nanofiltration membranes resemble the membranes of reverse osmosis. A thin selective layer lies on a support layer. In the context of the method according to the invention, spiral-wound modules are mostly used. Owing to their compact structure, it is possible to accommodate large membrane surface areas on a small surface area. This makes it possible to treat relatively large volumetric streams. The precondition for use of such spiral-wound modules is in all events a feed stream having low solid loading.

### Demineralization

The permeate from the preliminary stage has—optionally after concentrating—a content of dissolved phosphates in the order of magnitude of 1 to 2% by weight. It is optional but preferred to remove these salts also after separating off sodium salts and potassium salts.

In order to separate off the phosphates as completely as possible, the solutions are first adjusted to an approximately neutral pH in the range of 6 to 8 by adding bases, and the minerals which are substantially soluble phosphates, are admixed with an amount of a solution of a water-soluble calcium salt such that sparingly soluble calcium salts are precipitated. To adjust the pH and for precipitation, NaOH, an aqueous preparation of calcium chloride and alkali metal hydroxide, or calcium hydroxide are used. In principle, for adjusting the pH, other alkali metal bases or alkaline earth metal bases such as, e.g. -KOH can also be used. Also, the nature of the precipitation salt is itself non-critical, for example, barium salts may be precipitated. The use of calcium salts, however, has the advantage that the precipitation agent is inexpensive and the salts have a very low solubility product, and therefore the precipitation is substantially complete. Demineralization in stirred tanks also proceeds without addition of precipitation agents, wherein it has proved advantageous to adjust a temperature in the range of about 50 to 90° C., and preferably of about 80° C. The precipitation time is typically about 20 to 120 min and preferably about 30 to 45 min, wherein these statements are only to be understood as reference points, since lower temperatures demand longer reaction times and vice versa. After precipitation, the salts are separated off, for example in separators, which exploit the higher specific weight of the precipitated particles. However, it is likewise possible to perform the separation, for example by membrane filters, in the context of a further ultrafiltration in the range of 5000 to 150 000 daltons, preferably 10 000 to 50 000 daltons.

### Denaturation

In the following step, the protein-rich fraction from the ultrafiltration, that is to say the retentate R1, is combined with the permeate from the demineralization stage and subjected to a thermal treatment. The denaturation then proceeding can proceed in a manner known per se, namely over a period of about 5 to about 10 min, and preferably about 6 min, and temperatures of about 85 to about 90° C., and in particular about 88° C.

### Fermentation and Standardization

The fermentation of the denatured preliminary product can also proceed according to the known methods of the prior art. For this purpose, suitable starter cultures and rennet are added.

Preferably, the starter cultures contain
about 10 to about 90% by weight, preferably about 25 to about 75% by weight, and in particular about 40 to about 60% by weight of the mixture (i) and
about 90 to about 10% by weight, preferably about 75 to about 25% by weight, and in particular about 60 to about 40% by weight of the mixture (ii)
   with the proviso that the quantities total 100% by weight.

Particular preference is given to starter cultures which contain
about 40 to about 60% by weight of the mixture (i) and
about 60 to about 40% by weight of the mixture (ii)
   with the proviso that the quantities total 100% by weight.

In a further preferred embodiment, the five microorganisms which form the mixture (i) and also the three microorganisms which form the mixture (ii) are present in each case in about equal amounts. “About equal” in this context is taken to mean that in the mixture (i), the five microorganisms are each present in amounts of 20±5% by weight and in the mixture (ii), the three microorganisms are each present in amounts of 33±5% by weight. Instead of using the two commercially available preparations (i) and (ii) together, it is, of course, in principle also possible to use the five microorganisms individually and then to mix them in such a manner that a starter culture mixture is obtained, with which the enhanced taste quark products are obtained. Such starter cultures then contain, preferably
about 20 to about 30% by weight Streptococcus thermophilus,
about 5 to about 15% by weight Leuconostoc species,
about 5 to about 10% by weight Lactococcus lactis subsp. lactis biovar diacetylactis,
about 20 to about 30% by weight Lactococcus lactis subsp. lactis,
about 20 to about 30% by weight Lactococcus lactis subsp. cremoris, and
   with the proviso that the quantities total 100% by weight.

Particular preference is given to starter cultures containing
25% by weight Streptococcus thermophilus,
12% by weight Leuconostoc species,
13% by weight Lactococcus lactis subsp. lactis biovar diacetylactis,
25% by weight Lactococcus lactis subsp. lactis,
25% by weight Lactococcus lactis subsp. cremoris.

All stated microorganisms are freely available commercially.

The temperature at which the fermentation proceeds depends on the temperature range which is optimal for the microorganisms respectively used; typically, the temperature is in the range of about 18 to about 35° C., and preferably about 30° C. The quark base mix obtained after the fermentation is then adjusted to the desired content of dry matter and proteins, for example by adding cream. Preferably, the dry matter content is about 15 to about 20% by weight, and in particular about 18% by weight. The protein content can be about 10 to about 15% by weight, and preferably about 12% by weight.

### EXAMPLES

### Comparative Example C1

4 kg of skimmed milk were treated at 88° C. for 6 min and the resultant proteins were denatured. The mix was admixed with Bifido bacterium and rennet and ripened at 30° C. for about 18 h and then agitated. The fermentation product was then placed in a centrifuge and approximately 3.2 kg of acid whey were separated off as a liquid component. The remaining quark mix (approximately 800 g) was adjusted to a dry matter of 18% by weight and a protein content of 12% by weight by addition of cream.

In tasting, the product proved to be bitter/sandy and divergently unsuitable for consumption per se.

### Example 1

4 kg of skimmed milk were subjected at 20° C. to an ultrafiltration using a spiral-wound membrane (selectivity 25 000 daltons). The protein-rich retentate was separated off and the permeate was subjected at 20° C. to a nanofiltration using a spiral-wound membrane (selectivity 500 daltons). Sodium salts and potassium salts were separated off with the permeate. The retentate was then treated by addition of an aqueous calcium chloride solution adjusted to pH=6 with NaOH and the phosphates were precipitated as calcium phosphate. The resultant permeate was combined with the protein-rich retentate from the first step, treated at 88° C. for 6 min and the resultant proteins were denatured. The mix was admixed with a mixture of the two starter culture mixtures (i) and (ii) in the weight ratio 60:40 and admixed with rennet and stirred for about 2 h at 30° C. The fermentation product was then placed in a centrifuge and the acid whey was separated off as a liquid component. The remaining quark mix was adjusted to a dry matter of 18% by weight and a protein content of 12% by weight by addition of cream.

In tasting, the product proved to be free from bitter substances and was graded as immediately ready to eat.

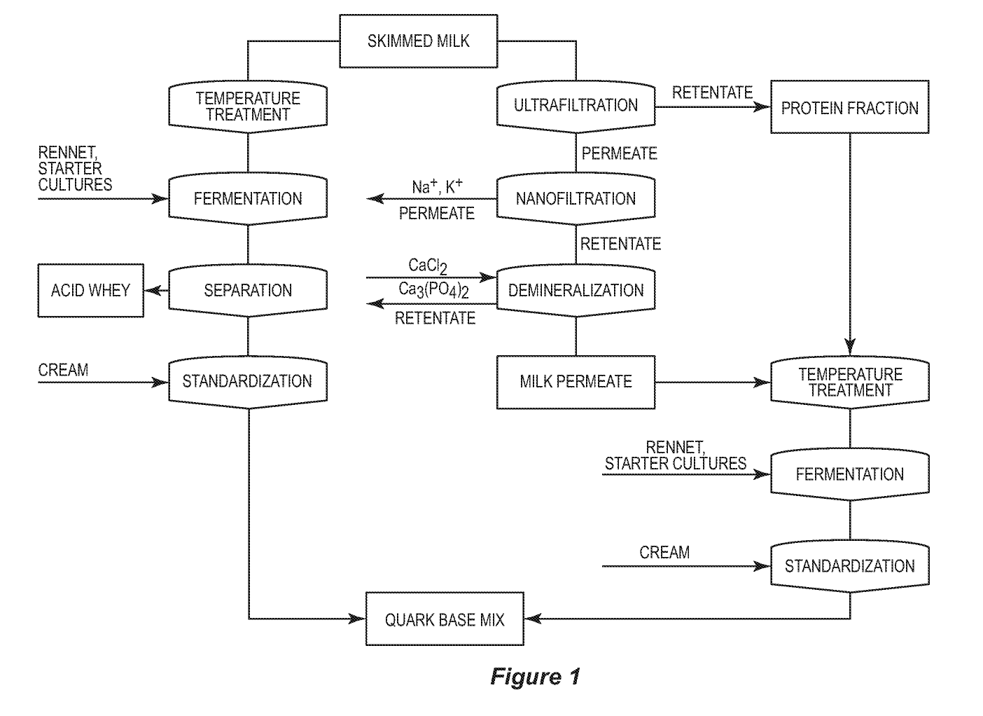

The two methods are reproduced as flowcharts in FIG. 1.

### Examples 2 to 4, Comparative Examples C2 to C4

Example 1 was repeated, but different starter cultures were used. Then, the products were evaluated for taste and sensory properties on a scale from 1 (=does not apply) to 6 (=applies fully) by a panel consisting of 5 experienced testers. The results are summarized in Table 1. Examples 2 to 7 are according to the invention, Example C2 acts again as comparison. The mean values of the evaluations are stated.

TABLE 1
Taste and sensory assessment of the quark base mixes

| | | Taste | Sensory quality | | |
|---|---|---|---|---|---|
| Ex. | Starter culture | Bitter | Creamy | Smooth | Slimy |
| C2 | Bifida bacterium | 5.5 | 3.0 | 2.0 | 5.5 |
| C3 | Mixture (i) | 3.0 | 2.5 | 2.0 | 4.0 |
| C4 | Mixture (ii) | 4.0 | 2.0 | 2.0 | 4.0 |
| 2 | Mixture (i + ii) = 75:25 | 2.0 | 4.0 | 3.5 | 2.0 |
| 3 | Mixture (i + ii) = 50:50 | 1.5 | 4.5 | 4.0 | 1.0 |
| 4 | Mixture (i + ii) = 25:75 | 2.5 | 4.0 | 3.5 | 1.5 |

The experiments and comparative experiments clearly show that the selection of the starter cultures has a considerable influence on the taste and sensory properties of the quark base mix. The quark base mix having the best properties, i.e. the lowest bitterness, the highest creaminess, which in addition does not leave a slimy impression, was achieved using a combination according to the invention of the mixtures (i) and (ii) in the weight ratio 1:1.

1. A quark base composition having enhanced taste properties, obtainable in that
(a) raw milk is subjected to a temperature treatment and the cream is separated off,
(b) the resultant skimmed milk is subjected to an ultrafiltration and/or reverse osmosis and in this case a first retentate R1 which contains a milk protein concentrate is produced, and a first permeate P1 is produced,
(c) the first permeate P1 is subjected to a nanofiltration and in this case a second retentate R2 which contains alkali metal salts is produced, and a second permeate P2 is produced,
(d) optionally the second permeate P2 is subjected to an alkaline demineralization and in this case a third retentate R3 which contains phosphate salts is produced, and a third permeate P3 is produced,
(e) the third permeate P3 or second permeate P2 is combined with the first retentate R1 in such a manner that a non-acidified quark base mix is formed, and
(f) the resultant mixture is subjected to a temperature treatment until denaturation occurs, and finally
(g) the denatured product is admixed with starter cultures and rennet and optionally
(h) the quark base mix obtained after completion of fermentation is adjusted to a defined dry matter content and protein content,
and in step (g), as starter culture
(i) a first mixture of five microorganisms comprising (i-1) Streptococcus thermophilus, (i-2) Leuconostoc species, (i-3) Lactococcus lactis subsp. lactis biovar diacetylactis, (i-4) Lactococcus lactis subsp. lactis and (i-5) Lactococcus lactis subsp. cremoris, and
(ii) a second mixture of three microorganisms comprising (ii-1) Streptococcus thermophilus, (ii-2) Lactococcus lactis subsp. lactis and (ii-3) Lactococcus lactis subsp. cremoris
are used in a ratio by weight (i):(ii) of from about 10:90 to about 90:10.

2. A method for producing a quark base mix having enhanced taste properties comprising the steps:
(a) subjecting raw milk to a temperature treatment and separating the cream off,
(b) subjecting the resultant skimmed milk to an ultrafiltration and/or reverse osmosis and in this case a first retentate R1 which contains a milk protein concentrate is produced, and a first permeate P1 is produced,
(c) subjecting the first permeate P1 to a nanofiltration and in this case a second retentate R2 which contains alkali metal salts is produced, and a second permeate P2 is produced,
(d) optionally subjecting the second permeate P2 to an alkaline demineralization and in this case a third retentate R3 which contains phosphate salts is produced, and a third permeate P3 is produced,
(e) combining the third permeate P3 or second permeate P2 with the first retentate R1 in such a manner that a non-acidified quark base mix is formed, and
(f) subjecting the resultant mixture to a temperature treatment until denaturation occurs, and finally
(g) mixing the denatured product with starter cultures and rennet, and optionally
(h) adjusting the quark base mix obtained after completion of fermentation to a defined dry matter content and protein content,
wherein said starter culture in step (g) represents a blend of
(i) a first mixture of five microorganisms comprising (i-1) Streptococcus thermophilus, (i-2) Leuconostoc species, (i-3) Lactococcus lactis subsp. lactis biovar diacetylactis, (i-4) Lactococcus lactis subsp. lactis and (i-5) Lactococcus lactis subsp. cremoris, and
(ii) a second mixture of three microorganisms comprising (ii-1) Streptococcus thermophilus, (ii-2) Lactococcus lactis subsp. lactis and (ii-3) Lactococcus lactis subsp. cremoris
in a ratio by weight (i):(ii) of from about 10:90 to about 90:10.

3. The method of claim 2, wherein the mixtures of the starter cultures are present in the weight ratio (i):(ii) of about 10:90 to about 90:10.

4. The method of claim 2, wherein said ultrafiltration is carried out using membranes that have a selectivity 1000 to 50,000 Dalton.

5. The method of claim 2, wherein said ultrafiltration or microfiltration is carried out using spiral-wound modules or plate-frame modules.

6. The method of claim 2, wherein said ultrafiltration or microfiltration is carried out at a temperature in the range of 10 to 55° C.

7. The method of claim 2, wherein said reverse osmosis is carried out using semi-permeable membranes which have a selectivity of 0 to 1000 daltons.

8. The method of claim 2, wherein said reverse osmosis is carried out at a temperature in the range of 10 to 55° C.

9. The method of claim 2, wherein said nanofiltration is carried out using membranes which have a selectivity of 100 to 1000 Dalton.

10. The method claim 2, wherein said nanofiltration is carried out using spiral-wound modules.

11. The method of claim 2, wherein said nanofiltration is carried out at a temperature in the range of 10 to 55° C.

12. The method of claim 2, wherein said phosphates are precipitated as calcium salts for demineralization.

13. The method of claim 2, wherein said demineralization is carried out at a temperature in the range of 50 to 90° C.

14. The method of claim 2, wherein said the combined product of permeate P3 and retentate R1 is subjected to a temperature treatment of 85 to 90° C. over a period of 5 to 10 min and denatured in the course of this.

15. The method of claim 2, wherein said the resultant denatured mix is admixed with cultures and rennet at 25 to 35° C.
